(19) United States
(12) Patent Application Publication
(10) Pub. No.: US 2010/0080690 A1
(43) Pub. Date: Apr. 1, 2010

(54) HYDRAULIC PUMP

(75) Inventors: Toshio Horie, Seto-shi (JP); Fumio Shimizu, Toyota-shi (JP); Shintaro Igarashi, Toyota-shi (JP); Hiroyuki Mori, Nisshin-shi (JP); Kenichi Suzuki, Nagoya-shi (JP); Yuji Yamamoto, Toyota-shi (JP); Yoshiaki Nakano, Toyohashi-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 12/568,276

(22) Filed: Sep. 28, 2009

(30) Foreign Application Priority Data
Sep. 29, 2008 (JP) 2008-249669

(51) Int. Cl. F03B 13/00

(52) U.S. Cl. 415/121.3

(57) ABSTRACT

A hydraulic pump includes a housing including an inlet port, an outlet port, and a fluid chamber, a shaft fixed to the housing, a rotor including an impeller portion that rotates relative to the shaft, the impeller portion suctioning and discharging a fluid, a fixed portion provided at the housing and made of an aluminum alloy, the fixed portion securing the shaft, a short-circuit portion provided at the shaft and made of a stainless steel having a nitrided layer at a surface, the short-circuit portion being supplied with a protection current from the fixed portion by galvanically making contact with the fixed portion, and a support portion rotatably supporting the rotor and formed by extending from the short-circuit portion, an outer peripheral surface of the support portion being covered with an amorphous carbon film of which a main component is carbon and which includes silicon.

### CROSS REFERENCE TO RELATED APPLICATIONS

This application is based on and claims priority under 35 U.S.C. §119 to Japanese Patent Application 2008-249669, filed on Sep. 29, 2008, the entire content of which is incorporated herein by reference.

### TECHNICAL FIELD

This disclosure relates to a hydraulic pump.

### BACKGROUND

A known hydraulic pump generally discharges, by means of a centrifugal force, a fluid that is suctioned via a rotation of an impeller. For example, JP2000-213349A (hereinafter referred to as Reference 1) discloses a hydraulic pump in which an impeller is fixed to a shaft that is driven to rotate the impeller for a purpose of suctioning and discharging the fluid. In addition, JP2005-299552A (hereinafter referred to as Reference 2) discloses a hydraulic pump in which a rotor having an impeller is driven to rotate around a shaft for a purpose of suctioning and discharging the fluid. In association with a high performance of the hydraulic pump such as a downsizing and a high output performance, a load applied to the shaft is increasing. Thus, an outer periphery of the shaft is covered with a protective film so as to improve a durability of the shaft. Specifically, according to a pump in which a rotor rotates around a shaft, a surface of the rotor is slidably in contact with an outer periphery of the shaft. Then, in order to enhance a sliding performance, the outer periphery of the shaft may be covered with an amorphous carbon film (DLC film). Specifically, an amorphous carbon film (DLC-Si film) including silicon is excellent and effective for an abrasion resistance, a solid lubricity, and the like. In a case where the shaft is made of an iron material such as stainless steel, in order to improve an adhesion performance between the stainless steel and the DLC-Si film, a surface treatment is generally conducted on the stainless steel.

A nitriding treatment may be provided on the stainless steel as the surface treatment for enhancing the adhesion performance between the stainless steel and the DLC-Si film. In the hydraulic pump, an LLC (Long Life Coolant) is generally used as a fluid to be suctioned or discharged. However, in a case where an LLC concentration is reduced in the hydraulic pump in which the stainless steel where the nitriding treatment is conducted is used for the shaft, it is found that the adhesion performance between the stainless steel and the DLC-Si film decreases.

Reasons of the low adhesion performance are as follows. In a case where the nitriding treatment is conducted on a base material made of stainless steel, nitrogen diffused on a surface layer of the base material is combined with chromium serving as an alloy element of the stainless steel. As a result, a complex compound constituted by chromium, nitrogen and carbon is likely to be formed. Thus, an area around the complex compound is a low chromium layer where chromium content is decreased. In the low chromium layer, a chromium concentration is lower than the surface layer of the base material before the nitriding treatment is conducted. A portion of the low chromium layer where the chromium concentration is below 12% by weight is no more regarded as the stainless steel and is an initiation point for corrosion because a stable passive film is prevented from being formed. Even when the low chromium layer is covered with the DLC-Si film, the corrosion is proceeded by means of a defect in the film as the initiation point, which leads to a reduction of the adhesion ability between the stainless steel and the DLC-Si film and further a delamination of the DLC-Si film. The reduction of the adhesion performance leads to a reduction of the sliding performance between the rotor and the shaft and therefore the corrosion resistance of the shaft further needs to improve so as to enhance the reliability and durability of the hydraulic pump.

As a method for improving the corrosion resistance, instead of the stainless steel generally used, the usage of an alloy of which corrosion resistance is greater than the stainless alloy is considered. However, in view of a material cost, a process cost, and the like, the usage of such alloy is difficult to realize. In addition, JP2002-285378A (hereinafter referred to as Reference 3) discloses a plated metal plate having a zinc alloy plating film. Zinc of which galvanic potential is sufficiently low in water is formed at a surface of the metal plate to conduct a sacrificial protection, thereby preventing a generation of a hole on the metal plate. However, in order to ensure the adhesion performance of the DLC-Si film by improving the corrosion resistance of the shaft over a long time period according to a method disclosed in Reference 3, a large quantity of zinc is required to be applied.

A need thus exists for a hydraulic pump which is not susceptible to the drawback mentioned above.

### SUMMARY

According to an aspect of this disclosure, an hydraulic pump includes a housing including an inlet port, an outlet port, and a fluid chamber connected to the inlet port and the outlet port, a shaft fixed to the housing, a rotor including an impeller portion that rotates relative to the shaft within the fluid chamber, the impeller portion suctioning a fluid from the inlet port and discharging the fluid from the outlet port, a fixed portion provided at the housing and made of an aluminum alloy, the fixed portion securing the shaft, a short-circuit portion provided at the shaft and made of a stainless steel having a nitrided layer at a surface, the short-circuit portion being supplied with a protection current from the fixed portion by galvanically making contact with the fixed portion, and a support portion rotatably supporting the rotor and formed by extending from the short-circuit portion, an outer peripheral surface of the support portion being covered with an amorphous carbon film of which a main component is carbon and which includes silicon.

### BRIEF DESCRIPTION OF THE DRAWINGS

The foregoing and additional features and characteristics of the disclosure will become more apparent from the following detailed description considered with the reference to the accompanying drawings, wherein:

FIG. 1 is a cross-sectional view schematically illustrating a hydraulic pump according to an embodiment;

FIG. 2 is a cross-sectional view illustrating an example of the hydraulic pump (an electric water pump);

FIG. 3 is a graph illustrating galvanic potentials of a nitrided stainless steel and an aluminum alloy; and

FIG. 4 is a schematic view explaining a measuring method of a protection current.

### DETAILED DESCRIPTION

An embodiment will be explained with reference to the attached drawings.

A hydraulic pump 90 includes a housing 91 that has an inlet port 911, an outlet port 91e and a fluid chamber 91f, a shaft 92 fixed to the housing 91, and a rotor 93 including an impeller portion 93P that rotates relative to the shaft 92 within the fluid chamber 91f.

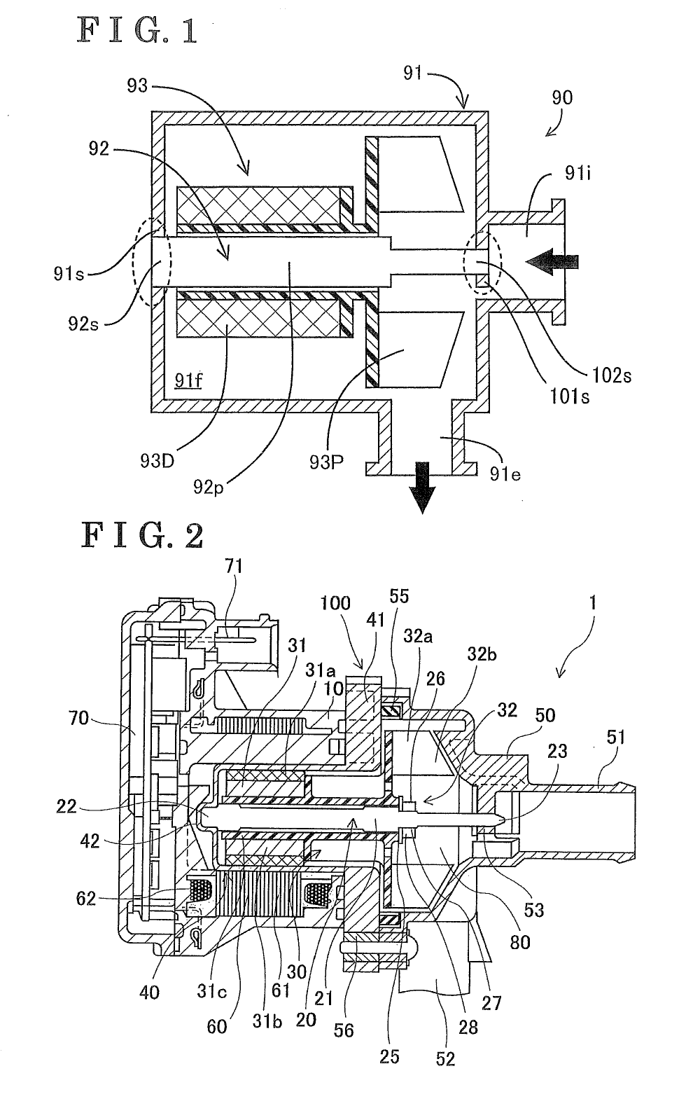

Specifically, the fluid chamber 91f is connected to both of the inlet port 91i and the outlet port 91e. Arrangements of the inlet port 91i and the outlet port 91e are not limited to those shown in FIG. 1 and are appropriately determined depending on a shape of the impeller portion 93P. At least a portion (i.e., a fixed portion which will be explained later) of the housing 91 is made of an aluminum alloy. That is, the housing 91 may be entirely formed by the aluminum alloy or may be constituted by a combination of multiple members formed by the aluminum alloy and by materials other than the aluminum alloy. The materials other than the aluminum alloy are, for example, metallic materials such as stainless, and resin materials. The composition of the aluminum alloy is not specifically determined and is appropriately determined depending on required strength and heat resistance. For example, in a case where the aluminum alloy has a specific strength equal to or greater than 50 MPa/cm³, the housing 91 appropriately serves as a housing of the hydraulic pump. In a case where the content of silicon serving as an additional element is 7.5% to 12% by weight provided the aluminum alloy is 100% by weight, a casting performance is excellent, which leads to an easy manufacturing of the housing having a complicated shape. Specifically, ADC12, ADC12Z, ADC10, ADC10Z and the like specified in JIS (Japanese Industrial Standard) are appropriate for use.

At least a portion of the shaft 92 is fixed to the housing 91. In FIG. 1, both axial end portions of the shaft 92 are fixed to the housing 91. In this case, however, at least a portion of the shaft 92 excluding a support portion 92p is fixed to the housing 91. The shaft 92 is made of stainless steel having a nitrided layer at a surface. In view of a reduction of load to a motor, an austenitic stainless steel that is a nonmagnetic material is applied to the shaft 92. Specifically, SUS304, SUS302, SUS310, SUS316, and the like specified in JIS are appropriate for use.

At least a surface of the shaft 92 where an amorphous carbon film is formed is nitrided. Alternatively, the entire surface of the shaft 92 may be nitrided. A nitriding treatment for forming the nitrided layer on the stainless steel is desirably achieved by an ion nitriding process, a gas nitriding process, or a molten salt nitriding process. Any of the aforementioned processes are applicable as long as the process is conducted under conditions for a normal surface treatment of the stainless steel. The nitriding treatment temperature is not specified, however, it is desirably in a range from 450° C. to 600° C., or, more specifically, in a range from 500° C. to 550° C. In addition, a depth of nitriding (i.e., a thickness of the nitrided layer) is not specifically determined, however, it is appropriately specified in a range from 4 μm to 50 μm, or more specifically, in a range from 10 μm to 30 μm. The nitriding treatment temperature and the nitriding depth specified in the aforementioned range are appropriate in view of an adhesion between the shaft 92 and the amorphous carbon film.

A galvanic potential is measured by using a silver-silver chloride electrode in tap water of which temperature is maintained at 80° C., the stainless steel having the nitrided layer (hereinafter referred to as a nitrided stainless steel) desirably indicates a galvanic potential value smaller than −100 mV and greater than −400 mV, specifically, the value smaller than −100 mV and greater than −380 mV. The nitrided stainless steel having the galvanic potential greater than −400 mV ensures a high corrosion resistance over a long time period by means of a sacrificial protection where the aluminum alloy serves as a sacrificial material. In this case, when the nitrided stainless steel indicates the galvanic potential equal to or greater than −100 mV, such nitrided stainless steel has a required corrosion resistance and thus is not applicable to the present embodiment.

The rotor 93 includes the impeller portion 93P that rotates relative to the shaft 92 within the fluid chamber 91f to suction a fluid from the inlet port 911 and discharges the fluid from the outlet port 91e. The rotor 93 is rotatably supported by the shaft 92 to thereby cause the impeller portion 93P to be rotatable within the fluid chamber 91f. A method for driving and rotating the rotor 93 is not specified. For example, the rotor 93 may include a rotating body 93D that corresponds to a rotor of an electric motor such as a commutator motor and an induction motor. In addition, a shape of the impeller portion 93P is not specifically determined.

According to the hydraulic pump 90 of the present embodiment, a portion of the housing 91 made of the aluminum alloy serves as the sacrificial material and is galvanically connected to a portion of the shaft 92 made of the nitrided stainless steel so as to conduct a sacrificial protection.

The housing 91 is made of the aluminum alloy as described above. The housing 91 includes a fixed portion 91s and/or 101s. In FIG. 1, the housing 91 includes the fixed portions 91s and 101s, however, at least one fixed portion may be galvanically in contact.

The shaft 92 is made of the nitrided stainless steel as described above. The shaft 92 includes a short-circuit portion 92s and/or 102s in addition to the support portion 92p.

The short-circuit portion 92s or 102s is galvanically in contact with the fixed portion 91s or 101s so as to receive a protection current from the housing 91. In FIG. 1, the shaft 92 includes the short-circuit portions 92s and 102s, however, at least one short-circuit portion may be desirably formed. In addition, in FIG. 1, the short-circuit portion 92s or 102s is provided at one end of the shaft 92. At this time, the position of the short-circuit portion is not specifically determined. The support portion 92p extends from the short-circuit portion 92s or 102s. The rotor 93 is rotatably supported by the support portion 92p.

The support portion 92p is coated or covered, at an outer peripheral surface, with an amorphous carbon film (DSC-Si film) of which main component is carbon and which includes silicon. The DLC-Si film is formed at least at a portion of an outer periphery of the shaft 92 that is slidably in contact with the rotor 93. The composition, the film thickness, and the like of the DLC-Si film are not specifically determined. For example, the DLC-Si film of which main component is carbon and which includes one or more of hydrogen, metal element, nitrogen, and oxygen in addition to silicon may be applied at the surface of the nitrided stainless steel. In view of an abrasion resistance and a solid lubricity, the DLC-Si film desirably includes 3% to 20%, specifically, 5% to 15% of silicon by atom, and 20% to 40%, specifically, 25% to 35% of hydrogen by atom provided the entire DLC-Si film is 100% by atom. The thickness of the DLC-Si film is desirably specified to be equal to or greater than 1 μm, specifically, 2 μm to 6 μm so as to coat or cover the surface of the nitrided stainless steel (i.e., the nitrided layer) not to be exposed. Such DLC-Si film is formed by means of known CVD method and PVD method such as a plasma CVD method, an ion plating method, and a spattering method.

A fluid used for the hydraulic pump 90 according to the embodiment desirably includes an LLC (Long Life Coolant) serving as cooling fluid. The LLC has the corrosion prevention ability. The hydraulic pump 90 according to the present embodiment still achieves an excellent durability even in a case where the LLC concentration is equal to or smaller than 5% by weight, more specifically, equal to or smaller than 3% by weight, provided the entire fluid is 100% by weight. Even in a case where the LLC having the corrosion prevention ability is not added to the cooling fluid and tap water including chlorine that has corrosiveness is used for the fluid, the sliding performance between the shaft 92 and the rotor 93 is still ensured, which leads to an excellent durability of the hydraulic pump 90 according to the embodiment.

Because the reliability of the hydraulic pump 90 of the present embodiment is not damaged even when the aluminum alloy serving as the sacrificial material is used for the housing material, a design of the hydraulic pump is not necessarily greatly changed. However, it is desirable to design the hydraulic pump 90 by considering dimensions of the housing 91 and the shaft 92, the surface treatment of the shaft 92, and the like so that a wearing level of the housing 91 (sacrificial material) is equal to or smaller than 10 μm per year.

The present embodiment is not limited to have the aforementioned structure. The aforementioned structure may be changed and modified within a scope of a main point of the embodiment.

Next, a case where the hydraulic pump 90 according to the present embodiment is applied to an electric water pump will be explained with reference to FIG. 2. An electric water pump 1 circulates cooling fluid within a cooling circuit that includes an engine and a radiator for a vehicle, for example. The cooling fluid is heated by absorbing heat generated at the engine and then cooled by emitting the heat to the radiator to thereby cool the engine.

The electric water pump 1 includes a housing 100 accommodating a fluid chamber 80, a shaft 20 fixed to the housing 100, and a rotor 30 including an impeller 32 (impeller portion) rotating within the fluid chamber 80 to suction and discharge the cooling fluid.

The housing 100 includes a main housing 10 serving as a first housing, a partition wall 40 serving as a second housing, and a case 50 to thereby define the fluid chamber 80. The housing 100 is formed by an aluminum alloy (ADC12). The partition wall 40 is formed into a substantially cylindrical shape having a bottom portion. The partition wall 40 includes a flange portion 41 at an outer periphery at an opening side. The partition wall 40 also includes a first fixed portion 42 at a center of the bottom portion formed into a recess shape when viewed from the opening side. One end of the shaft 20 is fixed to the first fixed portion 42. The case 50 is mounted via a seal member 55 on the flange portion 41 of the partition wall 40 by means of a tightening member 56 in a watertight manner. The case 50 includes an inlet port 51 connected to the radiator for suctioning the cooling fluid and an outlet port 52 connected to the engine for discharging the cooling fluid to the engine. The inlet port 51 and the outlet port 52 are both connected to the fluid chamber 80. The case 50 further includes a second fixed portion 53 that is formed between the fluid chamber 80 and the inlet port 51 in an inwardly projecting manner. The other end of the shaft 20 is connected to the second fixed portion 53.

The both ends of the shaft 20 have smaller diameters than that of a center. The shaft 20 is formed by a bar member made of a nitrided stainless steel (SUS304 nitrided material). The center of the shaft 20 forms a support portion 21 that rotatably supports the rotor 30. The both ends of the shaft 20 form a first short-circuit portion 22 and a second short-circuit portion 23, respectively, fixed to the housing 100 while galvanically making contact with the housing 100. Specifically, the shaft 20 is fixed to the housing 100 while the first short-circuit portion 22 is fitted to the recess of the first fixed portion 42 and the second short-circuit portion 23 is inserted into the second fixed portion 53. At this time, the aluminum alloy and the nitrided stainless steel are directly in contact with each other. DLC-Si film is formed at an outer peripheral surface of the support portion 21 of the shaft 20.

The shaft 20 includes a stepped portion 26 for axially positioning a thrust washer 25 that restricts an axial movement of the rotor 30. The shaft 20 further includes an external thread 27 to which a nut 28 for fixing the thrust washer 25 to the stepped portion 26 is fastened.

The rotor 30 includes a rotation member 31 and the impeller 32 integrally connected to the rotation member 31. The rotation member 31 includes a cylindrical portion 31c at which the impeller 32 is integrally formed. A magnetic member 31b is integrally fixed to an outer periphery of the cylindrical portion 31c. Further, a permanent magnet 31a having multiple polarities is fixed to an outer periphery of the magnetic member 31b. The multiple polarities are, for example, constituted by four poles of north poles and south poles alternately arranged in a circumferential direction. The cylindrical portion 31c is rotatably supported by the shaft 20 in a state where an inner peripheral surface of the cylindrical portion 31c is slidably in contact with the DLC-Si film formed at the outer peripheral surface of the support portion 21. The rotation member 31 is driven to rotate by means of a rotating magnetic field generated by a drive portion 60. The impeller 32 rotates together with the rotation member 31 within the fluid chamber 80 to thereby circulate the cooling fluid within the cooling circuit.

The impeller 32 includes a base portion 32a having a substantially circular disc shape and being perpendicular to the cylindrical portion 31c, and a blade portion 32b projecting towards the inlet port 51. The blade portion 32b of the impeller 32 rotates to thereby circulate the cooling fluid within the cooing circuit.

The electric water pump 1 includes the driver portion 60 and a power supply control portion 70 that controls an electric power supplied to the drive portion 60. The drive portion 60 is provided, being separated from the rotor 30 (rotation member 31), by means of the partition wall 40.

The drive portion 60 includes a core 61 having a projection that projects towards the permanent magnet 31a and a coil 62 wound on the core 61. The core 61 and the coil 62 are integrally formed by means of resin molding. The drive portion 60 is connected to the power supply control portion 70 that controls the power supply to the coil 62. The power supply control portion 70 includes a connector 71 connected to a wiring harness. When the power is supplied to the drive portion 60 from the power supply control portion 70 by means of an input signal from the outside, the permanent magnet 31a having the multiple magnetic poles in the circumferential direction, i.e., the rotor 30, starts rotating.

[Evaluation of Sacrificial Protection Efficiency]

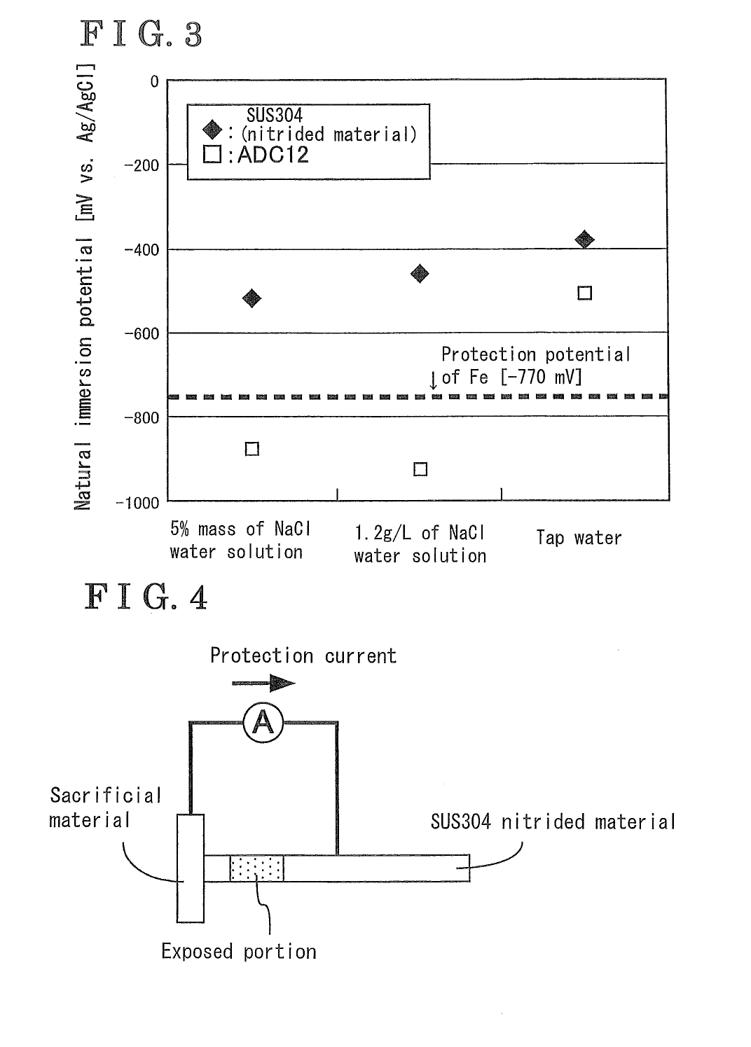

The galvanic potentials of the SUS304 nitrided material and the ADC12 used in the aforementioned embodiment were measured. The SUS304 nitrided material was obtained by conducting a plasma nitriding treatment on an entire SUS304 bar at 530° C. for one hour to form the nitrided layer having 23 μm on a surface of the SUS304 bar. A sample electrode obtained by the SUS304 nitrided material or the ADC12, and a reference electrode formed by a silver-silver chloride electrode were inserted in this order into a container filled with test solution (NaCl water solution or tap water). In such state, a potential difference ΔE (i.e., galvanic potential) between the sample electrode and the reference electrode was measured by a potentiometer. The test solution temperature during the measurement was specified to be 80° C. In addition, two types of NaCl water solution (two test solutions) were used. That is, one test solution includes 5% of NaCl concentration by weight while the other test solution includes 1.2 g/liter of NaCl concentration. The measurement result is shown in FIG. 3.

Next, in order to evaluate the effect of the sacrificial protection, each sacrificial material (ADC12, ZDC1 (zinc alloy)) and AZ91 (magnesium alloy) were directly in contact with the SUS304 nitrided material to form galvanic couples (test pieces No. 01, C1, and C2) to conduct an immersion test. In the immersion test, the test pieces No. 01, C1, and C2 were immersed for one hour in tap water (80° C.) which is unlikely to induce the sacrificial protection. In a test piece C3, the sacrificial material is not used and the SUS304 nitrided material only was immersed in tap water. The test result is sown in Table 1 below.

The red rust was generated in the test piece No. C3 where the sacrificial protection was not conducted. On the other hand, the red rust was not generated in the test pieces No. 01, C1 and C2. In addition, ADC12, on which the sacrificial protection is difficult as shown from the result of the galvanic potential in FIG. 3, was able to be used as the sacrificial material. This is because a matrix of the SUS304 nitrided material is austenite, and due to the protection efficiency of the addition element such as Ni and Cr.

Further, the protection currents of the test pieces No. 01, C1 and C2 were measured. The measuring method of the protection current is shown in FIG. 4. The sacrificial material in 20 mm×27 mm×5 mm (thickness), and the circular-column shaped SUS304 nitrided material having 7.5 mm in diameter and 60 mm in length were prepared. Then, the protection current flowing from the sacrificial material to the SUS304 nitrided material was measured when the sacrificial material and the SUS304 nitrided material were immersed in tap water at 80° C. in a state where one surface of the sacrificial material and an end surface of the SUS304 nitrided material were in contact with each other. At this time, a portion of a thickness surface of the sacrificial material and a portion of an outer peripheral surface of the SUS304 nitrided material were each covered with an insulating material. The one surface of the sacrificial material in 20 mm×27 mm and an area of 8 mm length of the peripheral surface of the SUS304 were not covered with the insulating material so that the sacrificial material and the steel were exposed.

Then, weight [gram/10 years] of the sacrificial material required for preventing a corrosion of 1 cm² of the SUS304 nitrided material for 10 years was calculated on the basis of the measured values. The calculation result is shown in Table 1. According to the test sample No. 01 in which ADC12 was used as the sacrificial material, the flowing protection current was small. Thus, a level of sacrificial corrosion was extremely small compared to the test piece No. C1 or C2. That is, when ADC12 is used for the housing material of the aforementioned electric water pump 1 as the sacrificial material, a function of the housing over a long time period is never damaged. Further, ADC12 has 64.2 MPa/cm² of specific strength and thus is appropriate for the housing material.

According to the evaluation of the sacrificial protection effect, the DLC-Si film was not applied at the surface of the SUS304 nitrided material. In the test piece No. 01 having the excellent corrosion resistance, the adhesion between the SUS304 nitrided material and the DLC-Si film is maintained for a long time period. Further, delamination of the SLC-Si film is also prevented.

TABLE 1

| | Test piece No. | | | |
|---|---|---|---|---|
| | 01 | C1 | C2 | C3 |
| Sacrificial material | ADC12 | ZDC1 | AZ91 | — |
| Steel surface condition | OK | OK | OK | NG: red rust is |
| | | | | generated |
| Sacrificial material required | 0.61 | 6.89 | 8.65 | — |
| for 1 cm² of steel | | | | |
| (g/10 years) | | | | |

According to the aforementioned embodiment, the sacrificial protection for preventing corrosion of a metal item by touching a piece of metal that is galvanically more reactive to the item to be protected is applied to the hydraulic pump 90, 1. The galvanic potential of the SUS304 that serves as the austenite stainless steel is −47 mV. On the other hand, the galvanic potential of the SUS304 on which the nitriding treatment is performed is −380 mV (see FIG. 3). That is, the galvanic potential of the SUS304 decreases when the nitriding treatment is performed thereon so that the corrosion resistance decreases. However, the galvanic potential of the nitrided SUS304 is greater than the galvanic potential of S45C (i.e., −529 mV) serving as carbon steel for machine structural use by 150 mV. Then, by means of a small sacrificial protection without bringing the protection potential equal to or smaller than that of the carbon steel, the corrosion protection of the nitrided stainless steel is sufficiently achieved. Further, with the usage of the aluminum alloy as the sacrificial material for the sacrificial protection, a level of corrosion of the sacrificial material is reduced.

That is, according to the hydraulic pump 90, 1 of the present embodiment, the fixed portion 91s, 101s, 42, 53 (housing 91, 100) made of aluminum alloy and the short-circuit portion 92s, 102s, 22, 23 (shaft 92, 20) made of stainless steel having the nitrided layer at a surface are galvanically in contact with each other. Then, the protection current is supplied from the fixed portion 91s, 101s, 42, 53 to the short-circuit portion 92s, 102s, 22, 23 to conduct the sacrificial corrosion. Because the protection current flowing from the aluminum alloy to the stainless steel having the nitrided layer is small and thus a level of corrosion is small. In addition, the aluminum alloy has a high strength and therefore appropriately serves as the housing material. The sacrificial material is not required to be added to the structure of the hydraulic pump 90, 1 because the housing 91, 100 functions as the sacrificial material. Consequently, the hydraulic pump is structured without greatly modifying the known design.

The sacrificial protection that is performed on the hydraulic pump 90, 1 enhances the corrosion resistance of the shaft 92, 20 and prevents a decrease of the adhesion between the DLC-Si film and the outer periphery of the shaft 92, 20. Because the adhesion of the DLC-Si film relative to the outer periphery of the shaft 92, 20 is maintained high, the excellent sliding properties therebetween are also maintained, which leads to the improved reliability and durability of the hydraulic pump 90, 1. Further, according to the hydraulic pump 90, 1 of the present embodiment, even when a fluid that may cause the corrosion of the shaft 92, 20 such as tap water is used, the corrosion of the shaft 92, 20 is unlikely to occur and delamination of the DLC-Si film is restrained.

According to the aforementioned embodiment, the stainless steel indicates a galvanic potential smaller than −100 mV and greater than −400 mV in a measurement of the galvanic potential by using a silver-silver chloride electrode in tap water maintained at 80° C.

The stainless steel indicates a galvanic potential smaller than −100 mV and greater than −380 mV in the measurement of the galvanic potential by using the silver-silver chloride electrode in tap water maintained at 80° C.

The nitrided layer of the shaft 92, 20 has a nitrided depth of 4 μm to 50 μm.

The nitrided layer of the shaft 92, 20 has the nitrided depth of 10 μm to 30 μm.

The stainless steel includes austenite stainless steel.

The aluminum alloy includes ADC12.

The fluid is one of cooling fluid having an LLC concentration equal to or smaller than 5% by mass and tap water.

The fluid is one of cooling fluid having the LLC concentration equal to or smaller than 3% by mass and tap water.

The amorphous carbon film includes 3% to 20% of silicon by atom provided the amorphous carbon film is 100% by atom as a whole.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A hydraulic pump comprising:
a housing including an inlet port, an outlet port, and a fluid chamber connected to the inlet port and the outlet port;
a shaft fixed to the housing;
a rotor including an impeller portion that rotates relative to the shaft within the fluid chamber, the impeller portion suctioning a fluid from the inlet port and discharging the fluid from the outlet port;
a fixed portion provided at the housing and made of an aluminum alloy, the fixed portion securing the shaft;
a short-circuit portion provided at the shaft and made of a stainless steel having a nitrided layer at a surface, the short-circuit portion being supplied with a protection current from the fixed portion by galvanically making contact with the fixed portion; and
a support portion rotatably supporting the rotor and formed by extending from the short-circuit portion, an outer peripheral surface of the support portion being covered with an amorphous carbon film of which a main component is carbon and which includes silicon.

2. The hydraulic pump according to claim 1, wherein the stainless steel indicates a galvanic potential smaller than −100 mV and greater than −380 mV in a measurement of the galvanic potential by using a silver-silver chloride electrode in tap water maintained at 80° C.

3. The hydraulic pump according to claim 2, wherein the stainless steel indicates the galvanic potential smaller than −100 mV and greater than −380 mV in the measurement of the galvanic potential by using the silver-silver chloride electrode in tap water maintained at 80° C.

4. The hydraulic pump according to claim 1, wherein the nitrided layer of the shaft has a nitrided depth of 4 μm to 50 μm.

5. The hydraulic pump according to claim 4, wherein the nitrided layer of the shaft has the nitrided depth of 10 μm to 30 μm.

6. The hydraulic pump according to claim 2, wherein the nitrided layer of the shaft has a nitrided depth of 4 μm to 50 μm.

7. The hydraulic pump according to claim 6, wherein the nitrided layer of the shaft has the nitrided depth of 10 μm to 30 μm.

8. The hydraulic pump according to claim 1, wherein the stainless steel includes an austenite stainless steel.

9. The hydraulic pump according to claim 2, wherein the stainless steel includes an austenite stainless steel.

10. The hydraulic pump according to claim 4, wherein the stainless steel includes an austenite stainless steel.

11. The hydraulic pump according to claim 1, wherein the aluminum alloy includes ADC12.

12. The hydraulic pump according to claim 2, wherein the aluminum alloy includes ADC12.

13. The hydraulic pump according to claim 4, wherein the aluminum alloy includes ADC12.

14. The hydraulic pump according to claim 8, wherein the aluminum alloy includes ADC12.

15. The hydraulic pump according to claim 1, wherein the fluid is one of cooling fluid having an LLC concentration equal to or smaller than 5% by mass and tap water.

16. The hydraulic pump according to claim 1, wherein the fluid is one of cooling fluid having an LLC concentration equal to or smaller than 3% by mass and tap water.

17. The hydraulic pump according to claim 2, wherein the fluid is one of cooling fluid having an LLC concentration equal to or smaller than 5% by mass and tap water.

18. The hydraulic pump according to claim 4, wherein the fluid is one of cooling fluid having an LLC concentration equal to or smaller than 5% by mass and tap water.

19. The hydraulic pump according to claim 8, wherein the fluid is one of cooling fluid having an LLC concentration equal to or smaller than 5% by mass and tap water.

20. The hydraulic pump according to claim 1, wherein the amorphous carbon film includes 3% to 20% of silicon by atom provided the amorphous carbon film is 100% by atom as a whole.
